(19) United States
(12) Patent Application Publication
(10) Pub. No.: US 2006/0145127 A1
(43) Pub. Date: Jul. 6, 2006

(54) Primed substrate comprising conductive polymer layer and method

(75) Inventor: James E. Lockridge, Minneapolis, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/027,190

(22) Filed: Dec. 30, 2004

(51) Int. Cl. H01B 1/12

(52) U.S. Cl. 252/500

(57) ABSTRACT

Methods of making a conductive sheet comprising conductive polymer and articles.

### BACKGROUND

Touch sensors provide an interface between an electronic system and operator. Rather than using a keyboard to type in data, for example, touch sensors allow the user to transfer information to a computer by touching a displayed icon, or by writing or drawing on a screen. In many applications a transparent touch screen is positioned over a display.

Several types of transparent touch sensors use resistive or capacitive techniques to detect touch location. A resistive touch sensor includes two layers of transparent conductive material, such as a transparent conductive oxide, separated by a gap. (See for Example U.S. Patent Application Publication US2003/0170456.) When touched with sufficient force, one of the conductive layers flexes to make contact with the other conductive layer. The location of the contact point is detectable by controller circuitry that senses the change in resistance at the contact point.

Resistive touch sensors operate based on actual contact between the conductive layers. As a touch panel is used, repeated mechanical flexing and compressions can cause breaks and/or delamination of the conductive layer. Such mechanical failures alter the resistance measured at least at the position of the failure, resulting in a failure of the touch screen to correctly identify the location of touch (e.g. the item being selected).

Accordingly, industry would find advantage in touch screens and conductive sheet materials having improved properties.

### SUMMARY

In one aspect, the invention relates to a method of making a conductive sheet comprising providing a substrate comprising a surface having a polymeric primer; coating the polymeric primer with a conductive coating composition comprising a conductive polymer, a polymeric binder, and a polar aprotic solvent; and drying the composition.

In another aspect, the invention relates to a conductive sheet comprising a a substrate having a surface comprising a polymeric primer; and a conductive polymer layer disposed on the primer wherein the conductive polymer layer comprises residual (i.e. less than 1 wt-%) polar aprotic solvent. The conductive sheet is particularly suitable for use in a touch screen.

The conductive sheet exhibits improved durability for example a durability of at least 50,000 rubs, 100,000 rubs, or 200,000 rubs according to the Rub Durability Test.

In each of these aspects, the primer is preferably partially soluble or swellable in the polar aprotic solvent. Further, the polymeric primer is preferably crosslinked. The polymeric primer is typically an acrylic resin, a polyvinyl resin, polyester, polyacrylate, polyurethane, and mixtures thereof. The substrate is preferably surface treated with a treatment selected from the group consisting of plasma, corona, flame, chemical oxidization, and chemical etching. The conductive polymer preferably comprises polythiophene and in particular polyethylenedioxythiophene polystyrene sulfonate. The polar aprotic solvent is preferably selected from the group consisting of alkyl sulfoxides, N-methyl pyrrolidone, amide solvent, and mixtures thereof. The polymeric binder is preferably an ethylenically unsaturated binder precursor that is radiation cured by exposure to ultraviolet light. The substrate is preferably transparent such as polyester.

### BRIEF DESCRIPTION OF THE DRAWINGS

The invention may be more completely understood in consideration of the following detailed description of various embodiments of the invention in connection with the accompanying drawings, in which:

FIG. 1 schematically illustrates a cross-section of the conductive layers of a touch sensor in accordance with an embodiment of the invention.

### DETAILED DESCRIPTION OF THE PREFERRED EMBODIMENTS

In the following description of the illustrated embodiments, references are made to the accompanying drawings that form a part hereof, and in which is shown by way of illustration, various embodiments by which the invention may be practiced. It is to be understood that other embodiments may be utilized, and structural and functional changes may be made without departing from the scope of the present invention.

The present invention relates to conductive layers, conductive (e.g. sheet or film) materials, methods of making conductive layers, and articles such as touch screens. Although a resistive touch sensor is exemplified, the conductive layer described herein can be employed in capacitive touch sensor articles as well.

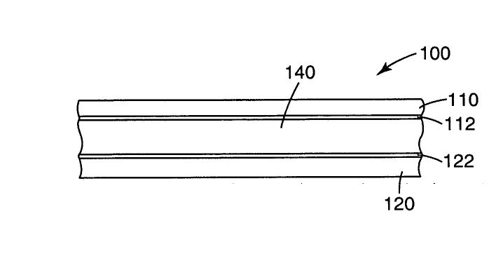

A typical resistive touch sensor is illustrated in FIG. 1. The touch sensor 100 includes, at least, a first conductive layer 112, typically provided on a first (e.g. top) substrate 110, and a second conductive layer 122 typically provided on a second (e.g. bottom) substrate 120, separated by a gap 140. The conductive layer can be continuous over the active area of the touch sensor or can be discontinuous (e.g. patterned). Prior to a touch, the conductive layers 112, 122 are separated, as shown in FIG. 1. The conductive layers are thus electrically isolated until a sufficient touch force is applied, and are electrically isolated upon removal of the sufficient touch force.

The substrates can be made of any suitable material, and are generally highly electrically insulating as compared to the conductive layers. Glass, ceramic materials, flexible plastic sheets or films, rigid plastics, and other such materials can be used. Suitable plastic materials include for example acrylic-containing film, a poly(vinyl chloride)-containing film, a poly(vinyl fluoride)-containing film, a urethane-containing film, a melamine-containing film, a polyvinyl butyral-containing film, a polyolefin-containing film, a cellulose acetate-containing film, a polyester-containing film, and a polycarbonate-containing film. The thickness of the substrate ranges from about 2 mils to about 10 mils, with a thickness of at least about 7 mils (e.g. for polyester) being preferred. Depending on the composition, the maximum film thickness is typically chosen that is sufficiently thin to allow for deformation upon touch.

In many applications, the touch sensor is provided as an overlay for an electronic display. For this embodiment, at least the substrate at the viewing surface is substantially transmissive of visible light. In other applications wherein graphics, text, or other indicia are provided between the user and the touch sensor, transparent substrate materials may not be required.

At least one of the substrate/conductive layer combinations is flexible, to allow deformation in response to an applied touch force, so that contact can be made between the first and second conductive layers within an area that corresponds to the characteristics of the touch input (location, size of touch implement, force of touch, etc.). Upon making electrical contact between the conductive layers, a signal can be measured that can be used to locate the position of the touch input, as is well known in the art. The other substrate/conductive layer combination can be rigid or flexible. If both substrates are flexible, it is preferred that the touch sensor be mounted onto a rigid support, for example onto the front glass plate of an electronic display screen.

Various approaches have been described for providing gap 140 between the first and second conductive layers. The gap can comprise air or another gas, a liquid, or a deformable and resilient material. For example, U.S. Pat. No. 6,469,267 describes maintaining an air gap with spacer elements. In another approach, spacer strips may be employed as described in U.S. Pat. No. 5,062,198. In yet another approach, microstructured conductive layers can be employed as described in U.S. 2004/0012570. In yet other patents, gap-filling materials may be employed, such as described in WO 03/094186 and WO 2004/010277. Although any technique can be utilized for providing the gap, the inclusion of spacer elements is typically preferred.

Presently described is a method of making a conductive sheet (e.g. for use in a touch screen). The method entails providing a substrate comprising a surface having a polymeric primer; coating the polymeric primer with a composition comprising a conductive polymer, a polymeric binder or precursor thereof, and a polar aprotic solvent; and optionally curing the composition. In other aspects, the invention relates to articles made by this method. In yet other aspects, the invention relates to conductive layers or article including a primed substrate wherein the conductive layer comprises residual aprotic solvent.

In preferred embodiments, the conductive sheet and articles comprising such sheet(s) exhibit improved durability. Without intending to be bound by theory, it is surmised that the improved durability is attributed, in part, to the polymeric primer of the substrate being partially soluble or swellable in the aprotic solvent of the conductive polymer containing composition.

The “Rub Durability” of a conductive sheet or touch sensor can be evaluated by use of various techniques. The Rub Durability as measured according to the test method described in the forthcoming examples is at least 50,000 rubs until the phase angle is greater than 2 degrees. In some embodiments, the Rub Durability is at least 100,000 rubs, at least 150,000 or at least 200,000 rubs until the phase angle is greater than 2 degrees. The Rub Durability may even exceed 250,000 rubs until the phase angle is greater than 2 degrees. A phase angle of greater than 2 degrees is indicative of the onset of a significant reduction in conductivity of the conductive layer prior to failure. The number of rubs to failure can be significantly greater, for example four times that to produce a phase angle of greater than 2 degrees (e.g. greater than 1 million rubs).

A polymeric primer composition is provided on the substrate. Preferably, the substrate is surface treated such as plasma treated, corona treated, flame treated, or chemically oxidized or etched before applying the primer coating. For example, corona treatment may be applied at about 0.2 millijoules per square centimeter (mJ/cm²) of film surface area. Higher corona treatment levels can be used if desired.

The primer is generally provided as an aqueous or solvent-based coating composition that optionally comprises a crosslinker. However, radiation curable primer compositions, comprising a single radiation curable monomer, oligomer, macromonomer, polymer or mixtures thereof, are also contemplated. The primer composition typically comprises one or more film-forming resins. Upon evaporation of the solvent and/or upon radiation curing, the primer composition typically forms a continuous film.

Various film-forming resins are known. Representative film-forming resins include acrylic resin(s), polyvinyl resin(s), polyester(s), polyacrylate(s), polyurethane(s), polyolefin(s) having comonomers such as acrylic acid, polyethylene imine and other polymeric amine containing materials, as well as mixtures thereof. A suitable crosslinker is typically added, based on the particular polymeric binder or combination thereof, thereby forming a crosslinked polymeric matrix.

Solvent-based primer compositions comprise the base polymer admixed with a solvent. The solvent may be a single solvent or a blend of solvents. The solvent-based primer composition preferably contains about 2 to about 60 parts by weight of the base polymer, more preferably about 5 to about 30 parts base polymer and most preferably about 5 to about 15 parts base polymer, with the remainder of the primer composition being solvent and optional additives.

Various acrylic film-forming resins are known. In general, acrylic resins are prepared from various (meth)acrylate monomers such as polymethylmethacrylate (PMMA), methyl methacrylate (MMA), ethyl acrylate (EA), butyl acrylate (BA), butyl methacrylate (BMA), n-butyl methacrylate (n-BMA) isobutylmethacrylate (IBMA), polyethylmethacrylate (PEMA), etc. alone or in combination with each other.

Suitable polyurethane primers include for example water-borne urethane dispersions such as commercially available from NeoResins, Wilmington, Mass. under the trade designations “Neorez R-960”, “Neorez R-966” and “Neorez R-9679”. Suitable silyl terminated sulfopoly (ester-urethanes) are described in U.S. Pat. No. 5,929,160.

Suitable polyester primers include sulfonated polyesters such as those described in U.S. Pat. No. 5,468,498.

Other suitable resins include for example, polyvinylidine dichloride, commercially available from W. R. Grace, Cambridge, Mass., under the trade designation “Daran SL-112”; polyethylene acrylic acid commercially available from Michelman Inc, Cincinnati, Ohio under the trade designation “Michem Prime”; acrylic resins commercially available from Rohm and Haas Company, Philadelphia, Pa., under the trade designation “Acrysol WS-50”; and polyethylene imine, commercially available from Aceto Corp., Flushing, N.Y., under the trade designation “Eponmin PEI SP-12”.

In some instances, the primer may be pre-applied to the substrate such as in the case of polyester films commercially available from E.I. Dupont under the trade designation of Melinex 606/285 Teijin HSPE. (Teijin is a Dupont subsidiary)

In other instances, the primer composition (e.g. coating composition) may be applied on the substrate prior to applying the conductive composition. The primer compositions can be coated onto the (e.g. corona treated) substrate with various known techniques such as spin-coating, coating from a flat film die, knife coating, dip coating, spray coating, electrostatic spray coating, roll coating, printing and similar processes. The wet coating thickness of the primer is determined by the application method, the drying conditions, viscosity of the solutions, draw ratio of the film, and the desired dry coating thickness. Typical dry coating thickness prior to application of the conductive polymer coating can range from about 10 nm to about 500 nm and is more typically approximately 50 nm to 200 nm.

When the film substrate is oriented, the primer coating composition can be applied before, during, or after the orientation process. As used herein, “oriented” generally means uniaxial or biaxial drawing of a cast film to impart certain desirable characteristics to the film such as optical clarity and physical toughness. In particular, the coating composition may be applied to the substrate after it has been drawn in the machine direction but before it has been subsequently drawn in the transverse direction.

The conductive layer is prepared from a coating composition comprising conductive polymer, polymeric binder (e.g. precursor) and a polar aprotic solvent. Optional additives may be added as desired. For example, in the case of UV cured polymer binder precursors, it is common to employ a photoinitiator. The coating composition may also be diluted with solvents such as water and alcohols. Further, the composition may also comprises nonconductive particles as further described in concurrently filed patent application Attorney Docket No. 59631 US002, incorporated herein by reference.

The polymeric binder or precursor thereof is soluble in the polar aprotic solvent. Although the conductive polymer may also be soluble, typically the conductive polymer is dispersible in the polar aprotic solvent. The primer composition of the primed surface of the substrate is typically partially soluble or swellable in the aprotic solvent.

Typically the solvent is first chosen based on the conductive polymer and optional polymeric binder. Then a suitable primer is chosen for the substrate based on the solvent of the conductive polymer coating composition.

A variety of conductive polymers suitable for use in the conductive layer are known. Suitable conductive polymers include for example substituted and unsubstituted polypyrrole, polyaniline, polyacetylene, polythiophene, polyphenylene vinylene, polyphenylene sulfide, poly p-phenylene, polyheterocycle vinylene, and materials disclosed in European Patent Publication EP-1-172-831-A2.

One preferred conductive copolymer is polyethylenedioxythiophene polystyrene sulfonate (PEDT:PSS), commercially available from H.C. Starck, Leverkusen, Germany, under the trade designation “Baytron P.” As further described in U.S. Pat. No. 6,248,818, because of being doped with polystyrene sulfonate (PSS), the Bayton P conductive polymer disperses in water in addition to having good transparency in combination with exhibiting good thermal and atmospheric stability. High compatibility in water, alcohol, and solvents of large dielectric constants makes it easy to prepare a coating solution of high coatability.

One or more alcohols are typically present in the conductive polymer coating composition to serve as a solvent for the PEDT polymer. Useful are alcohols containing 1-4 carbon atoms, exemplified by methanol, ethanol, propanol, isopropanol and butanol. Most preferable is a mixture of two or three alcohols that differ from each other in boiling point. While being vaporized in sequence, the mixed alcohols assure the coating of a highly dispersed state of the PEDT conductive polymer.

The alcohol solvent is typically present in an amount of at least about 55 wt-% and typically no more then about 85 wt-%. Insufficient alcohol solvent can result in poor dispersibility.

The conductive polymer is typically provided in a polymeric binder matrix.

The polymeric matrix imparts desired mechanical properties to the conductive polymer material. The weight ratio of the conductive polymer to polymeric binder matrix is between 1 to 99 and 99 to 1, with a ratio between 9 to 1 and 1 to 9 being typical.

Suitable polymeric matrix materials include, but are not limited to, water-soluble or water-dispersible polymers such as gelatin, gelatin derivatives, maleic acid or maleic anhydride copolymers, cellulose derivatives (such as carboxymethyl cellulose, hydroxyethyl cellulose, cellulose acetate butyrate, diacetyl cellulose, and triacetyl cellulose), polyvinyl alcohol, poly-N-vinylpyrrolidone, and sulfonated polyester. Other suitable binders include organic solvent soluble or polar solvent soluble (e.g. alcohol soluble) as well as aqueous emulsions of addition-type homopolymers and copolymers prepared from ethylenically unsaturated monomers such as acrylates including acrylic acid, methacrylates including methacrylic acid, acrylamides and methacrylamides, itaconic acid and its half-esters and diesters, styrenes including substituted styrenes, acrylonitrile and methacrylonitrile, vinyl acetates, vinyl ethers, vinyl and vinylidene halides, and olefins; and solvent soluble or aqueous dispersions of polyurethanes or polyesterionomers; or a polysiloxane.

The binder is typically provided as a binder precursor, i.e. one or more materials that crosslink upon curing. One preferred binder is an ethylenically unsaturated binder precursor that is cured, for example, with ultraviolet light.

Various ethylenically unsaturated binder precursors are known such as those described in U.S. Pat. No. 6,299,799.

Various polar aprotic solvents are known. Suitable polar aprotic solvents include for example, alkyl sulfoxides, N-methylpyrrolidone, and various amide solvents. Particularly in the case of polythiophene conductive polymers such as PEDT:PSS, amide solvents are preferred Suitable amide solvents can be represented by the following formula:
R¹(CO)NR², R³
wherein, R¹, R² and R³, are independently H, CH₃ or —CH₂ CH₂ CH₂—. Examples of the amide solvents include formamide (FA), N-methylformamide (NMFA), N,N-dimethylformamide (DMF), acetamide (AA), N-methylacetamide (NMAA), N,N-dimethylacetic amide (DMA), N-methylpropion amide (NMPA) and N-methylpyrrolidone.

In order to produce the conductive coating composition, the conductive polymer is dissolved in the solvent (s). This takes place at a temperature between the melting and boiling point of the solvent or solvent mixture employed, preferably below about 80° C., and in particular below 50° C., if appropriate with stirring or other mixing techniques. It is then most preferred to add the polymeric binder after the conductive polymer/solvent mixture has been cooled to below about 40° C. and more preferably below about 20° C. If desired, the other additives are then added.

The conductive coating composition is applied to the surface of the substrate comprising the polymeric primer composition with any of the methods previously described for application of the primer composition.

The conductive coating composition is then dried. The conductive layer typically has a thickness of at least about 30 nanometers. Further, the conductive layer typically has a thickness of no greater than about 1000 nanometers. Upon drying, a detectable amount (i.e. a few parts per billion) of residual aprotic solvent typically remains. In order that the amount of residual solvent does not detract from the improved durability, it is preferred that the amount of residual solvent is minimized (e.g. less than 1%, less than 0.5%, less than 0.2%, less than 0.1%).

Advantages of the invention are further illustrated by the following examples, but the particular materials and amounts thereof recited in the examples, as well as other conditions and details, should not be construed to unduly limit the invention. All percentages and ratios herein are by weight unless otherwise specified.

### EXAMPLES

Polymeric Primed Substrate

Various films having a polymeric primer were utilized in the Examples. Two different polyester films having a pre-applied polymeric primer were obtained from E.I. Dupont under the trade designations “Teijin HSPE” and “Melinex 606/285”.

The other polymeric primer substrates were prepared by air-knife coating a corona-treated, length-oriented polyethyleneterephthalate (PET) film with the indicated primer composition followed by crossweb stretching, commonly known as tentering. The typical wet thickness of the pre-tenter-applied primer coating was about 6 micrometers and solution concentrations were 9 to 12%. The final film thickness of the PET was typically 2 mils.

Primer Composition 1 was prepared by adding 170 grams of crosslinker (commercially available from Neoresins, Wilmington, Mass. under the trade designation “NeoCryl CX-100”) to 9860 grams of water with stirring. 6800 grams of water-borne ethylene acrylic acid (commercially available from Michelman Inc, Cincinnati, Ohio under the trade designation “Michem Prime 4983R”) was then added followed by the addition of 170 grams of a 10% solution (wt/wt in water) of surfactant (commercially available from Union Carbide under the trade designation “Triton X-100”).

Primer Composition 2 was prepared by adding 3777.8 grams of polyvinylidine dichloride, commercially available from W. R. Grace, Cambridge, Mass., under the trade designation “Daran SL-112”, to 13052 grams of water with stirring, followed by the addition of 170 grams of the10% solution of Triton X-100 surfactant.

Primer Composition 3 was prepared by adding 170 grams of NeoCryl CX-100 crosslinker to 12633 grams of water with stirring followed by the addition of 4026 grams of acrylate polymer, commercially available from Rohm and Haas Company, Philadelphia, Pa., under the trade designation “Acrysol WS-50”, followed by the addition of 170 grams of a 10% solution of Triton X-100.

Primer Composition 4 was prepared by adding 156.4 grams of NeoCryl CX-100 crosslinker to 16245.2 grams of water with stirring followed by the addition of 428.4 grams of polyethylene imine, commercially available from Aceto Corp., Flushing, N.Y., under the trade designation “Eponmin PEI SP-12”, followed by the addition of 170 grams of a 10% solution of Triton X-100.

Primer Composition 5 was prepared by adding 4121 grams of water-borne urethane, commercially available from Neoresins, Wilmington, Mass. under the trade designation “Neorez 960”, to 12709 grams of water with stirring, followed by the addition of 170 grams of the 10% solution of Triton X-100 surfactant.

Primer Composition 6 was prepared by adding 1150 grams of core-shell polymer prepared according to U.S. Pat. No. 5,500,457, Example 1A, to 10954 grams of water with stirring, followed by the addition of 2462 grams of a copolymer prepared according to U.S. Pat. No. 4,098,952, Example 3, followed by 578 grams of a 20% solution of melamine crosslinker, commercially available from Cytec Industries, West Paterson, N.J., under the trade designation “Cymel 327”, followed by the addition of 578 grams of a 20% solution of melamine crosslinker, commercially available from Cytec Industries, West Paterson, N.J., under the trade name “Cymel 373”, followed by the addition of 170 grams of a 10% solution of Triton X-100 surfactant, followed by the addition of 1000 grams of water-borne ethylene acrylic acid (commercially available from Michelman Inc., Cincinnati, Ohio under the trade designation “Michem Prime 4983R”).

Primer Composition 7 was prepared by adding 8500 grams of sulfonated polyester, prepared according to U.S. Pat. No. 5,468,498, polymer K, to 8500 grams of water with stirring.

Comparative Example A comprises a conductive film coated with the same conductive polymer, polyethylenedioxythiophene polystyrenesulfonate (PEDT:PSS), commercially available from Agfa Corporation, Mortsel, Belgium under the trade designation “Agfa EL 1500”.

Comparative Example B was prepared by coating the described NMAC-based conductive coating onto a PET film that was pre-treated with a corona discharge but was not subsequently coated with a primer composition.

Comparative Example C was prepared using the Daran PVDC primer composition as described in Primer Composition 2 but omitting corona pre-treatment of the PET web prior to coating.

NMAC Conductive Coating Composition

20 grams of N-methylacetamide (NMAC) was heated to about 30° C. and added dropwise, with stirring, to 80 grams of polyethylenedioxythiophene polystyrenesulfonate (PEDT:PSS), commercially available from H.C. Starck, Leverkusen, Germany, under the trade designation “Baytron P”. The solution was then cooled to approximately 15° C. The following solvents were then added dropwise: 20 grams of ethanol, 30 grams of iso-propanol (IPA), and 92.8 grams of n-butanol. Finally, 15 grams of a pre-mix of 10% acrylate, commercially available from Sartomer, West Chester, Pa., under the trade designation “SR444” and 0.25% of photoinitiator commercially available from BASF, Mt. Olive, N.J. under the trade designation “Lucirin TPO” in IPA was added drop-wise with stirring. This solution was then stirred for approximately 10 minutes.

DMSO Conductive Coating Composition

In a similar manner, 56 grams of dimethylsulfoxide (DMSO) was added, dropwise with stirring, to 89.6 grams of Baytron P followed by cooling to approximately 15° C. and sequential addition of 22.4 grams ethanol, 33.6 grams IPA, 70.3 grams butanol, and 16.8 grams of an IPA pre-mix consisting of 10% SR444 and 0.25% Lucirin TPO as described above.

The pre-primed PET was then coated with the indicated conductive polymer solution using a #20 wire-wound Meyer-rod. The coating was allowed to dry at room temperature for 3 minutes. The samples were then placed in a 120° C. oven with impinging airflow for approximately 15 minutes. Finally, the coatings were cured with ultraviolet lights in a nitrogen-inert atmosphere under a 300-watt D-type bulb at a rate of 15 ft/min. The thickness of the cured conductive polymer layer was approximately 370 nm.

Each of the Examples were subjected to “Rub Durability Testing” as described as follows:

Rub Durability Testing method:

Two sheets of the pre-primed PET film coated with the same conductive layer, measuring approximately 4″×6″ (10 cm×15 cm) were used. The sheets were stacked with the conductive layers facing each other with spacers applied to mimic spacer elements. Each sheet was connected through a copper bar to a test fixture capable of measuring the electrical properties of the touch screen mock-up. The test fixture applies an AC voltage (approximately 5 V) to one sheet and measures the current, impedance, phase angle, capacitance and resistance between the two sheets. A third sheet of 7 mil PET was used between the top conductive sheet and the Personal Data Assistant stylus. Mechanical stress was applied by rubbing a Personal Data Assistant stylus back and forth across a 1 inch (2.54 cm) section of the film. The stylus pressure was 250 g and the rate of rubbing was 54 cycles/minute. When good electrical contact occurs between the top and bottom conductive layers, the phase angle and capacitance are zero and the resistance is equal to the impedance. When damage occurs to the conductive layers, the capacitance and phase angles become non-zero and the resistance and impedance are no longer equal.

Table 1 as follows shows the number of rub cycles endured by the conductive coatings until the phase angle becomes greater than 2 degrees.

TABLE 1

| | Conductive Coating | Rubs to Failure |
|---|---|---|
| Example 1 - Primer | DMSO-Based PEDT:PSS | 70,000 |
| Example 2 - Primer 2 | NMAC-Based PEDT:PSS | >650,000 |
| Example 3 - Primer 3 | NMAC-Based PEDT:PSS | >80,000 |
| Example 4 - Primer 3 | DMSO-Based PEDT:PSS | >473,000 |
| Example 5 - Primer 4 | DMSO-Based PEDT:PSS | >222,000 |
| Example 6 - Primer 5 | NMAC-Based PEDT:PSS | 226,300 |
| Example 7 - Primer 6 | NMAC-Based PEDT:PSS | >175,000 |
| Example 8 - Primer 6 | DMSO-Based PEDT:PSS | 165,000 |
| Example 9 - Primer 7 | NMAC-Based PEDT:PSS | 225,000 |
| Example 10 - Primer 7 | DMSO-Based PEDT:PSS | >200,000 |
| Example 11 - Melinex | NMAC-Based PEDT:PSS | >240,000 |
| 606/285 | | |
| Example 12 - Teijin HSPE | NMAC-Based PEDT:PSS | >170,000 |
| Comparative Example A | | 800-1500 |
| Comparative Example B - | NMAC-Based PEDT:PSS | 1 |
| corona treatment | | |
| (no polymeric primer) | | |
| Comparative Example C - | NMAC-Based PEDT:PSS | 1000 |
| Primer 2 without | | |
| corona treatment | | |

The results show that the primer in combination with a conductive coating having an aprotic solvent improves the Rub Durability of the coated substrate (i.e. conductive sheet material.

The present invention should not be considered limited to any particular examples described above, but rather should be understood to cover all aspects of the invention as fairly set out in the attached claims. Various modifications and equivalent processes, as well as numerous structures to which the present invention may be applicable will be readily apparent to those of skill in the art to which the present invention is directed upon review of the instant specification.

What is claimed is:

1. A method of making a conductive sheet comprising:
providing a substrate comprising a surface having a polymeric primer;
coating the polymeric primer with a conductive coating composition comprising a conductive polymer, a polymeric binder, and a polar aprotic solvent; and
drying the composition.

2. The method of claim 1 wherein the conductive sheet exhibits a durability of at least 50,000 rubs according to the Rub Durability Test.

3. The method of claim 1 wherein the conductive sheet exhibits a durability of at least 100,000 rubs according to the Rub Durability Test.

4. The method of claim 1 wherein the conductive sheet exhibits a durability of at least 200,000 rubs according to the Rub Durability Test.

5. The method of claim 1 wherein the primer is partially soluble or swellable in the polar aprotic solvent.

6. The method of claim 1 wherein the polymeric primer is crosslinked.

7. The method of claim 1 wherein the polymeric primer is selected from an acrylic resin, a polyvinyl resin, polyester, polyacrylate, polyurethane, polyethylene acrylic acid, polyethylene imine, and mixtures thereof.

8. The method of claim 1 wherein the substrate is surface treated with a treatment selected from the group consisting of plasma, corona, flame, chemical oxidization, and chemical etching.

9. The method of claim 1 wherein the conductive polymer is a thiophene-containing polymer.

10. The method of claim 9 wherein the conductive polymer is polyethylenedioxythiophene polystyrene sulfonate.

11. The method of claim 1 wherein the polymeric binder is crosslinked.

12. The method of claim 1 wherein the polar aprotic solvent is selected from the group comprising alkyl sulfoxides, N-methylpyrrolidone, amide solvent, and mixtures thereof.

13. The method of claim 1 wherein the polymeric binder is an ethylenically unsaturated binder precursor.

14. The method of claim 1 wherein the curing comprises radiation curing.

15. The method of claim 14 wherein the curing comprises ultraviolet curing.

16. The method of claim 1 wherein the substrate is transparent.

17. The method of claim 1 wherein the substrate comprises polyester.

18. A conductive sheet comprising a
a substrate having a surface comprising a polymeric primer; and
a conductive polymer layer disposed on the primer wherein the conductive polymer layer comprises residual polar aprotic solvent.

19. The conductive sheet of claim 18 wherein the concentration of residual solvent is less than 1 wt-%.

20. A touch screen comprising the conductive sheet of claim 18.
